(19) United States
(12) Patent Application Publication
(10) Pub. No.: US 2009/0204387 A1
(43) Pub. Date: Aug. 13, 2009

(54) Gaming Machine

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 12/264,553

(22) Filed: Nov. 4, 2008

Related U.S. Application Data
(60) Provisional application No. 61/028,309, filed on Feb. 13, 2008.

(51) Int. Cl. G06F 17/28

(52) U.S. Cl. 704/3; 704/231

(57) ABSTRACT

A message display area 85 of a sub monitor 111 provided in each station 101 displays contents uttered by each player through a microphone 116 provided in each station 101 in an output language of the station 101 in question. The contents displayed on the message display area 85 are outputted as speech from a speaker 117. The speech outputted from speaker 117 is outputted in the output language of the station 101 in question, as well. If the output language differs from the language used by the player when the player makes an utterance through the microphone 116 of the station 101, the setting of the output language is changed to the language used by the player. The setting of the output language is changed by using a language selecting button 88 displayed on the sub monitor 111. The player can specify one or all stations 101. The specified station 101 outputs contents uttered by the player. When the player specifies one or all stations 101, a station selecting button 89 displayed on the sub monitor 111 is used.

### CROSS-REFERENCE TO RELATED APPLICATIONS

This application is based upon and claims a priority from the U.S. Provisional Patent Application No. 61/028,309 filed on Feb. 13, 2008, the entire contents thereof are incorporated herein by reference for all purposes.

### BACKGROUND

1. Field

The disclosure relates to a gaming machine that outputs an answer to a player.

2. Description of Related Art

A conventional conversation control apparatus outputs a reply or answer in response to an utterance. Such a conversation control apparatus is disclosed in US Patent Application Publication 2007/0094004A1, US Patent Application Publication 2007/0094005A1, US Patent Application Publication 2007/0094006A1, US Patent Application Publication 2007/0094007A1, US Patent Application Publication 2007/0094008A1 or US Patent Application Publication 2007/0033040A1.

When the conversation control apparatus is mounted in a gaming machine, information on game history and the like can be interactively exchanged between a player and the gaming machine.

Gaming arcades such as casinos in which gaming machines are installed are more and more widely used internationally. Some gaming machines support multi-player games in which two or more players can enter simultaneously. Thus, it is desirable that interactive information exchange is instantly carried out even between players that do not speak the same language.

The above-mentioned conversation control apparatus returns a predetermined answer sentence in a predetermined language in response to an utterance made by a player. On the one hand, exchange of information between players often changes in the information contents and used language, when the exchange time for information exchange and the players themselves change. Accordingly, handling of information exchange between players that cannot speak each other's language by simply mounting the above-described conversation control apparatus in the gaming machine raised problems.

### SUMMARY

Here, the disclosure has been made in light of the above, and it is an object of the disclosure to provide an innovative gaming machine which has a speech translation function suitable for amusement.

To achieve the object of the disclosure, there is provided a gaming machine has a plurality of stations, each station comprising: an output device to which speech data or character data corresponding to conversation information with respect to a game history is outputted in an output language set in the station; an input device that converts a speech of a player into speech data; a speech recognition device that identifies a language of the speech data; a character conversion device that converts the speech data whose language was identified in the speech recognition device into character data in the identified language; a translation device that converts character data converted in the character conversion device into character data in the output language; a speech conversion device that converts the character data converted in the character conversion device or translation device into speech data in the output language; a communication device that carries out data communication with respect to other stations; a station selecting device that selects one station from the other stations; and a processor that is programmed to cause the communication device to transmit speech data that was converted in the input device to the station selected by the station selecting device, and at the same time, is programmed to execute processing (1) through (3) as follows: (1) identifying the language of the speech data that is received from the other stations through the communication device by the speech recognition device: (2) if the language identified at the processing (1) coincides with the output language, converting the speech data received at the processing (1) into character data in the language identified at the processing (1) by the character conversion device, and outputting the character data or the speech data thus converted to the output device in the output language; and (3) if the language identified at the processing (1) differs from the output language, subjecting the speech data received at the processing (1) to a first conversion into character data in the language identified at the processing (1) by the character conversion device, subjecting the character data that was subjected to the first conversion to a second conversion into character data in the output language by the translation device, and subjecting the character data that was subjected to the second conversion to a third conversion into speech data in the output language by the speech conversion device, and outputting the character data that was subjected to the second conversion or the speech data that was subjected to the third conversion to the output device in the output language.

Furthermore, according to another aspect, there is provided a gaming machine having a plurality of stations, each station comprising: an output device to which speech data or character data corresponding to conversation information with respect to a game history is outputted in an output language set in the station; an input device that converts a speech of a player into speech data; a speech recognition device that identifies a language of the speech data; a character conversion device that converts the speech data whose language was identified in the speech recognition device into character data in the identified language; a translation device that converts character data that was converted in the character conversion device into character data in the output language; a speech conversion device that converts the character data converted in the character conversion device or translation device into speech data in the output language; a communication device that carries out data communication with respect to other stations; a station selecting device that selects one station from the other stations; a language selecting device that selects one language from a plurality of languages; and a processor that is programmed to cause the communication device to transmit speech data that was converted in the input device to the station selected by the station selecting device, and at the same time, if a same game is executed simultaneously in the station and another station, the processor is programmed to execute processing (1) through (7) as follows in a timing required by a player of the station to make an utterance regarding the game with respect to a player of the station selected by the station selecting device: (1) identifying the language of the speech data that is received from the other stations through the communication device by the speech recognition device; (2) if the language identified at the processing (1) coincides with the output language, converting the speech data received at the processing (1) into character data in the language identified at the processing (1) by the character conversion device, and outputting the character data or the speech data thus converted to the output device in the output language; (3) if the language identified at the processing (1) differs from the output language, subjecting the speech data received at the processing (1) to a first conversion into character data in the language identified at the processing (1) by the character conversion device, subjecting the character data that was subjected to the first conversion to a second conversion into character data in the output language by the translation device, and subjecting the character data that was subjected to the second conversion to a third conversion into speech data in the output language by the speech conversion device, and outputting the character data that was subjected to the second conversion or the speech data that was subjected to the third conversion in the output device in the output language; (4) identifying the language of the speech data converted in the input device by the speech recognition device; (5) maintaining the setting of the output language, if the language identified at the processing (4) coincides with the output language; (6) changing the setting of the output language to the language identified at the processing (4), if the language identified at the processing (4) differs from the output language; and (7) changing the setting of the output language to the language selected in the language selecting device.

### BRIEF DESCRIPTION OF THE DRAWINGS

FIG. 1 is a view showing the characteristics of a gaming machine according to a present embodiment;

FIG. 2 is an outline view of the same gaming machine;

FIG. 3 is an outline view showing a station constituting the same gaming machine;

FIG. 4 is a block diagram of a host constituting the same gaming machine;

FIG. 5 is a block diagram of a station constituting the same gaming machine;

FIG. 6 is a block diagram of a conversation control circuit in the station constituting the same gaming machine;

FIG. 7 is a view showing an example of a display for a sub monitor in the station constituting the same gaming machine;

FIG. 8 is a view showing an example of a display for the sub monitor in the station constituting the same gaming machine;

FIG. 9 is a flow chart diagram showing an example of the operation in the same gaming machine;

FIG. 10 is a flow chart diagram showing a setting interrupt processing in each station constituting the same gaming machine;

FIG. 11 is a flow chart diagram showing a speech input interrupt processing in each station constituting the same gaming machine;

FIG. 12 is a flow chart diagram showing a speech data interrupt processing in each station constituting the same gaming machine;

FIG. 13 is a flow chart diagram showing a conversation control processing; and

FIG. 14 is a flow chart diagram showing the conversation control processing.

### DETAILED DESCRIPTION

### [1. Characteristics of the Disclosure]

Next, a detailed description will be given on the embodiments of the present disclosure by referring to the accompanying drawings. A gaming machine according to the present embodiment has a plurality of stations. Each station executes the same card game at the same time. This card game is draw poker.

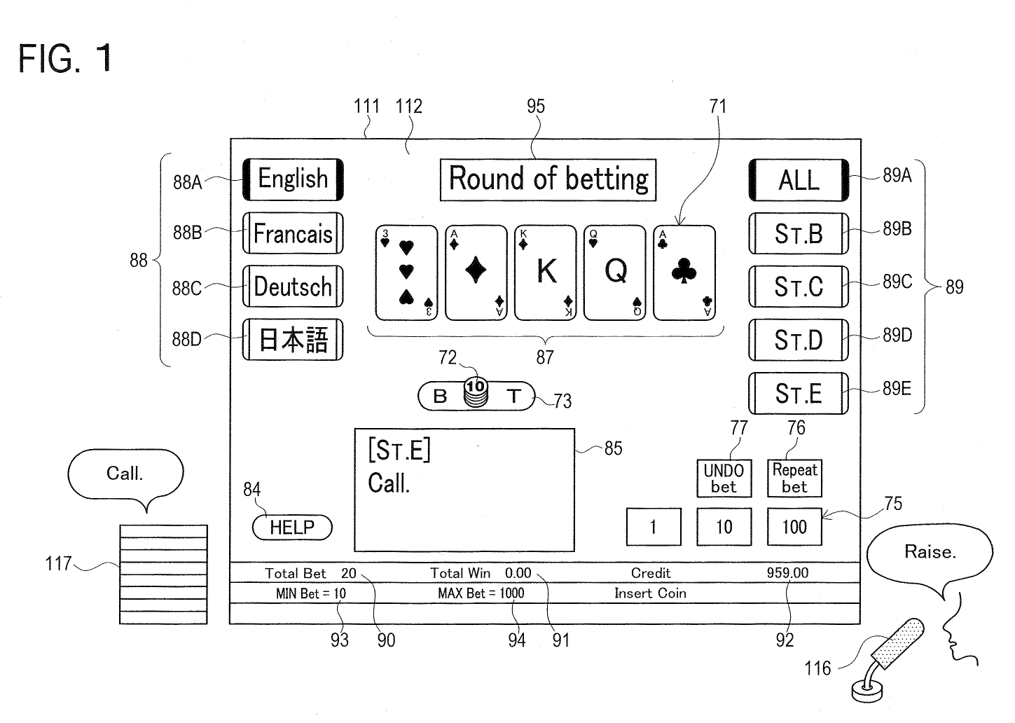

FIG. 1 is a view showing the characteristics of a gaming machine according to the present embodiment. Each station in the gaming machine according to the present embodiment includes a sub monitor 111, a microphone 116 and a speaker 117, and the like, as shown in FIG. 1. Above the sub monitor 111 is provided a touch panel 112.

The sub monitor 111 includes a player's card display area 71, a chip display area 73, a message display area 85 and a game progress display area 95 and the like. When a draw poker game is started, the player's card display area 71 displays five player's cards 87. The game progress display area 95 displays a progress state and the like of the draw poker game. For instance, at a betting round, the game progress display area 95 displays “Round of Betting”. The chip display area 73 displays an image 72 of the chips that the player of the station bet during the betting round.

The message display area 85 displays contents uttered by each player through the microphone 116 provided in each station, in an output language which is set for that respective station. For instance, when the output language set for the station is English, the message “Call.” is displayed on the message display area 85 as shown in FIG. 1, if the contents spoken by the player during the betting round has the meaning of a call for draw poker. The message display area 85 of FIG. 1 displays “Call.” and “[st.E]. The message “[st.E]” shows that the “Call.” represents the contents uttered by the player at station E. The contents displayed in the message display area 85 are outputted as speech from the speaker 117. The speech outputted from the speaker 117 is represented in the output language set in that station.

If this output language differs from the language used by that player when the player makes an utterance through the microphone 116 of the station, the language setting is changed to the language which is used. The output language setting is changed by touching a language selecting button 88 displayed on the sub monitor 111, through the touch panel 112.

In FIG. 1, the language selecting button 88 includes an English selecting button 88A, a French selecting button 88B, a German selecting button 88C and a Japanese selecting button 88D. Both ends of the English selecting button 88A are displayed in a specific color. The output language which is currently set is shown by displaying both ends of the language selecting button 88 in a specific color, as described above.

Accordingly, in FIG. 1, since the output language in the station is set to English, setting of the output language is never changed, even if the player at that station utters “Raise.” in English, through the microphone 116.

The player can specify one or all stations. The specified station outputs contents uttered by the player. When the player specifies one or all stations, a station selecting button 89 displayed on the sub monitor 111 is used. The station selecting button 89 and the sub monitor 111 will next be described in detail.

### [2. Example of a Gaming Machine Configuration]

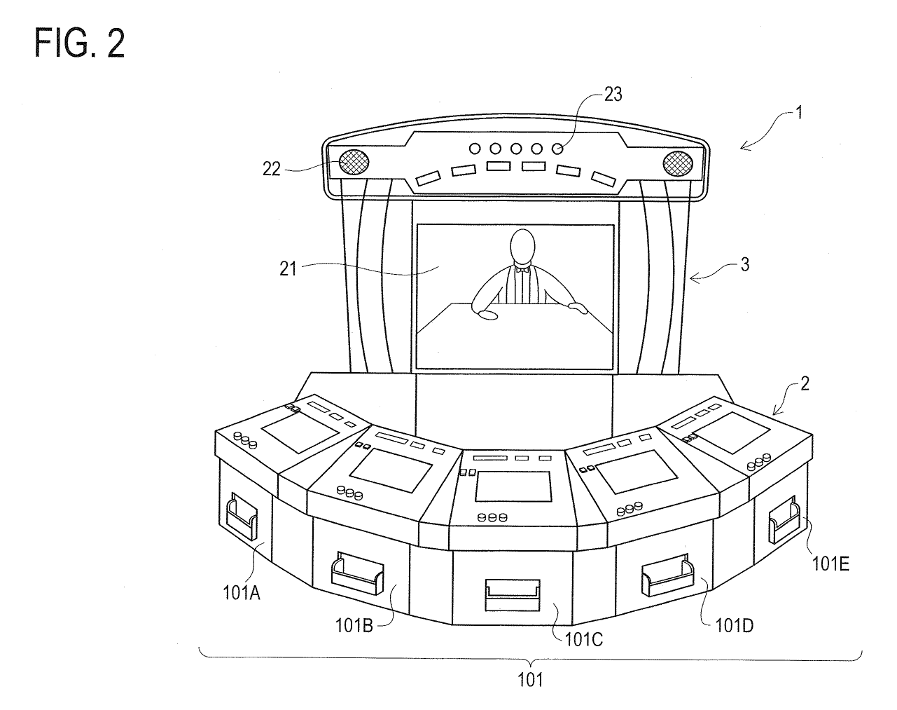

A schematic configuration of the gaming machine according to the present embodiment will now be described. FIG. 2 is an outline view of a gaming machine 1 according to the present embodiment. The gaming machine 1 according to the present embodiment is basically constituted of a table portion 2 and a panel portion 3. A player sits on a chair and plays a game at the table portion 2. The panel portion 3 is installed at the back of the table portion 2. The panel portion 3 displays an animation image and the like of a dealer.

The panel portion 3 is constituted of a main monitor 21, a speaker 22 and a display device 23 and the like. The main monitor 21 displays an image of a dealer who deals the cards and transfers chips, and the contents and the like of the cards that were dealt. The speaker 22 outputs music and other sound effects and the like in accordance with the progress of the game. The display device 23 lights up at the time of various effects.

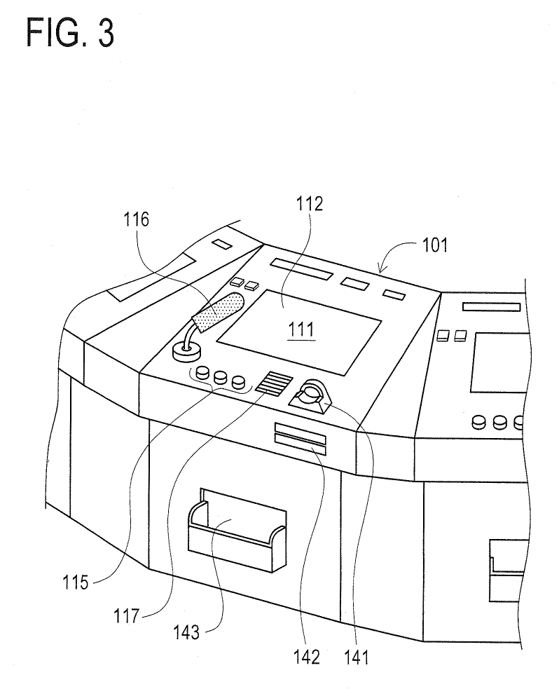

Table portion 2 includes a plurality of stations 101 arranged in a fan-like fashion. In FIG. 2, five stations 101 are installed. The five stations 101 include station A, station B, station C, station D and station E, starting from the right side in FIG. 2. FIG. 3 is an outline view showing one of these stations 101.

As shown in FIG. 3, each station 101 has the sub monitor 111, the touch panel 112, an operation button 115, a coin insertion portion 141, a bill insertion portion 142, a coin payout portion 143, the microphone 116 and the speaker 117 or the like.

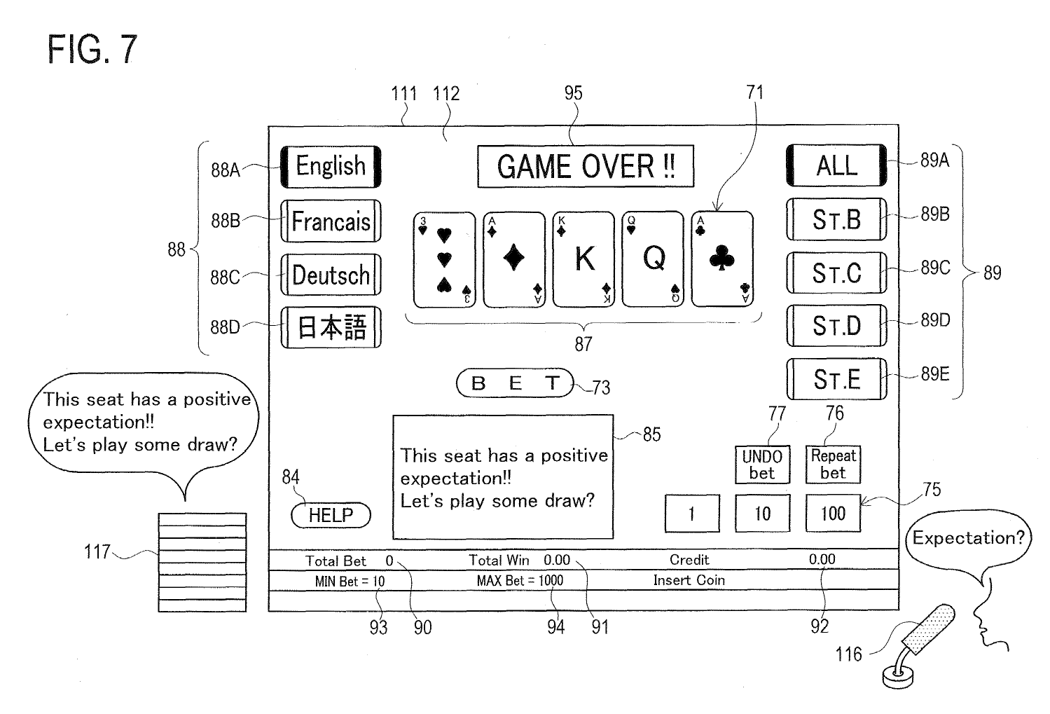

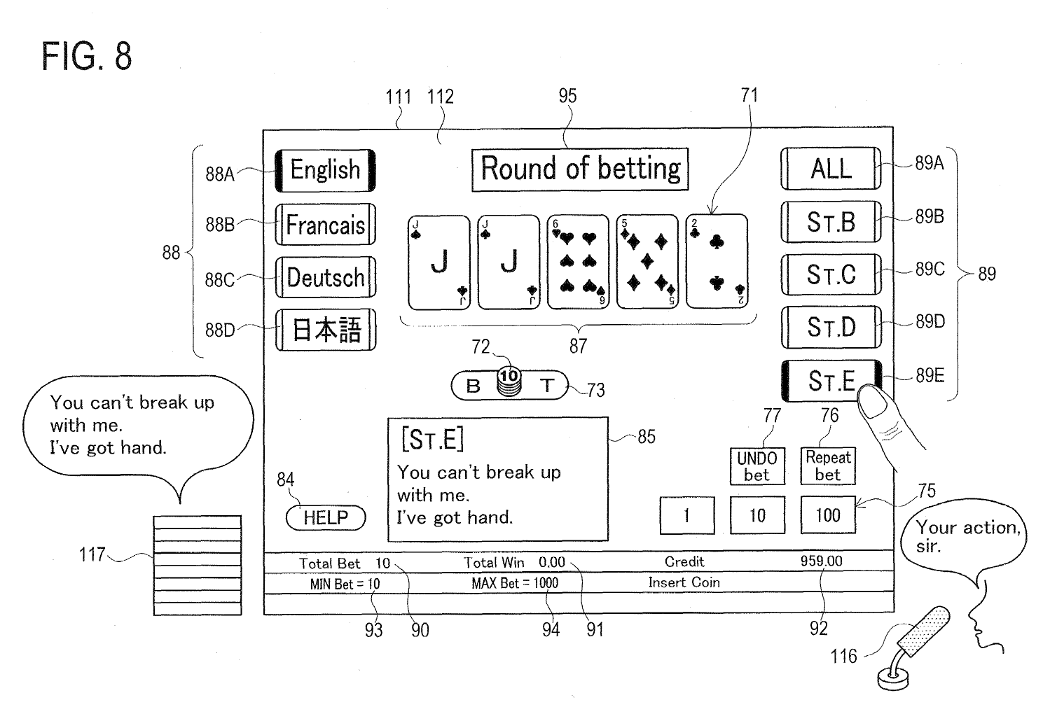

The sub monitor 111 displays a game screen (refer to the above-described FIG. 1, and FIG. 7 and FIG. 8 to be described later) and the like. The touch panel 112 is arranged at a front face of the sub monitor 111. The touch panel 112 is used in the selection operation of the respective buttons displayed on the sub monitor 111. The touch panel 112 is also used in the rearrangement operation/selection operation of the player's cards 87 displayed on the sub monitor 111. The operation button 115 serves to carry out a payout operation and the like. The coin insertion portion 141 serves to insert a coin or a medal. The bill insertion portion 142 serves to insert a bill or a ticket having a barcode. The coin payout portion 143 serves to payout a coin or medal corresponding to an accumulated credit, at the time a payout operation is carried out.

The microphone 116 captures the speech of the player. The speech captured by the microphone 116 is outputted from the speaker 117 using the output language. Further, the speaker 117 also outputs music and sound effects and the like in accordance with the progress of the game.

### [3. Example of a Host Configuration]

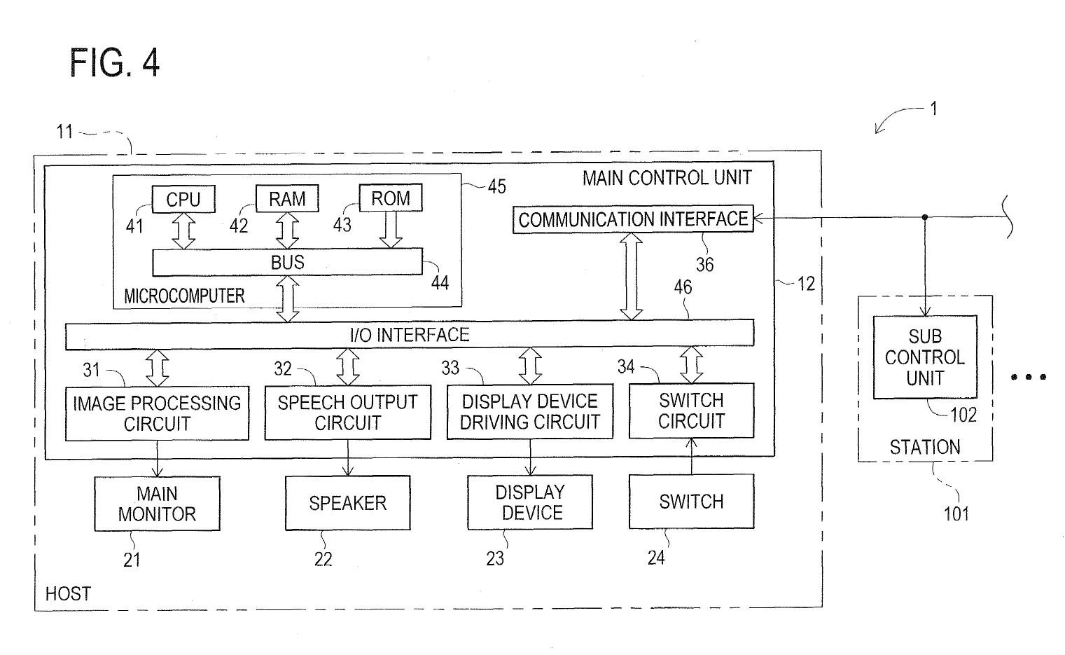

A host is an opposite concept with respect to each station 101 and is the core of the gaming machine 1 in the present embodiment. FIG. 4 is a block diagram showing a host 11. As shown in FIG. 4, the host 11 is constituted of a main control unit 12, the main monitor 21, the speaker 22, the display device 23 and a switch 24, or the like. The main control unit 12 is separated with the main monitor 21, the speaker 22 and the display device 23. The switch 24 consists of a dip switch and is attached to the main control unit 12. The switch 24 may also be separately provided.

The main control unit 12 includes a microcomputer 45 as its core. The microcomputer 45 is constituted of a CPU 41, a RAM 42, a ROM 43 and a bus 44 for data transfer amongst the above components. The CPU 41 is connected to the RAM 42 and the ROM 43 through the bus 44. The RAM 42 is a memory that serves to temporarily store various types of data and the like computed by the CPU 41. The ROM 43 stores various types of programs and data tables and the like for executing the necessary processing to control the gaming machine 1.

The microcomputer 45 is connected to an image processing circuit 31 through an I/O interface 46. The image processing circuit 31 is connected to the main monitor 21. The output of the main monitor 21 is controlled by the image processing circuit 31 based on a control signal from the CPU 41.

The microcomputer 45 is connected to a speech output circuit 32 through the I/O interface 46. The speech output circuit 32 is connected to the speaker 22. The output of the speaker 22 is controlled by the speech output circuit 32 based on a control signal from the CPU 41.

The microcomputer 45 is connected to a display device driving circuit 33 through the I/O interface 46. The display device driving circuit 33 is connected to the display device 23. The display on the display device 23 is controlled by the display device driving circuit 33 based on a control signal from the CPU 41. As a result, a light effect and the like with respect to the entire game is obtained.

The microcomputer 45 is connected to a switch circuit 34 through the I/O interface 46. The switch circuit 34 is connected to the switch 24. The switch 24 serves to input an instruction through a setting operation carried out by an operator, to the CPU 41 by means of a switch signal from the switch circuit 34. The language which represents character data or speech data to be transmitted from the host 11 to each station 101 can be changed through a setting operation by the operator using the switch 24. The switch 24 is arranged inside a case at a lower side of the main monitor 21. To operate the switch 24 from outside of the case, the operator must open a door provided in the case with a key.

The microcomputer 45 is connected to a communication interface 36 through the I/O interface 46. The communication interface 36 is connected to a sub control unit 102 of each station 101. As a result, communication in two directions becomes possible between the CPU 41 and each station 101. The CPU 41 performs command transmission and reception, request transmission and reception, data transmission and reception, and the like, with each station 101, through the communication interface 36. Accordingly, in the gaming machine 1, the main control unit 12 controls progression of the game in cooperation with each station 101.

### [4. Example of a Station Configuration]

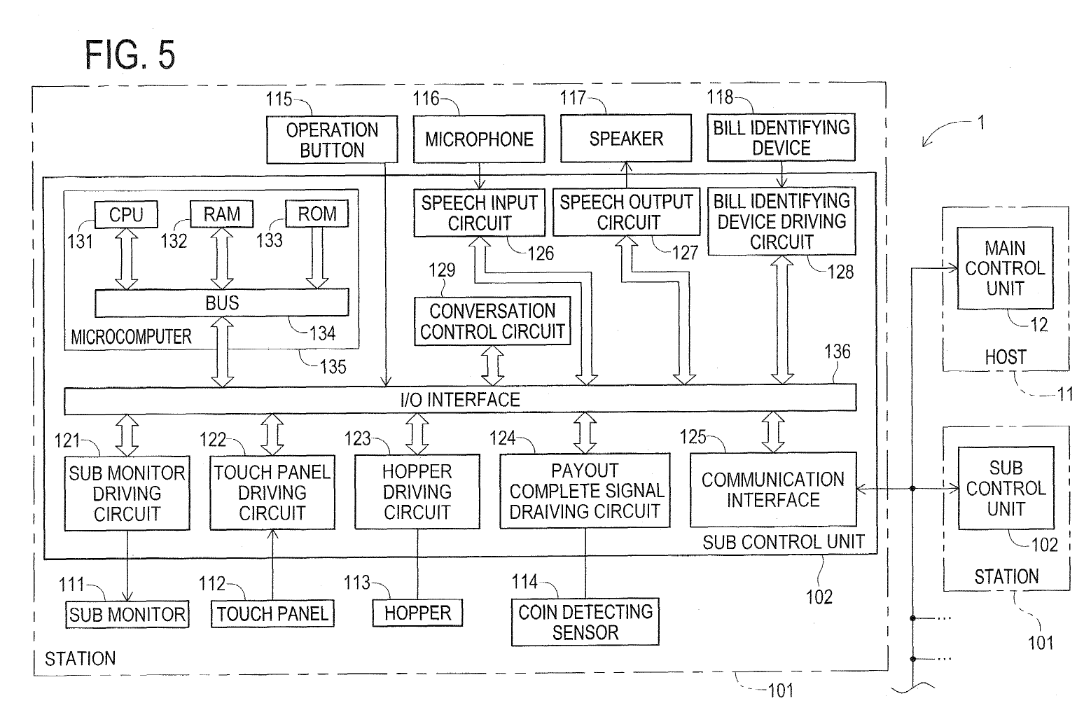

FIG. 5 is a block diagram showing the station 101. As shown in FIG. 5, the station 101 is constituted of the sub control unit 102, the sub monitor 111, the touch panel 112, a hopper 113, a coin detecting sensor 114, the operation button 115, the microphone 116, the speaker 117 and a bill identifying device 118 and the like.

The sub control unit 102 is constituted with a microcomputer 135 as its core. The microcomputer 135 is constituted of a CPU 131, a RAM 132, a ROM 133 and a bus 134 for data transmission among these components. The CPU 131 is connected to the RAM 132 and the ROM 133 through the bus 134. The RAM 132 serves to temporarily store various types of data and the like computed by the CPU 131. The ROM 133 stores various types of programs and data tables and the like for executing the necessary processing to control the gaming machine 1.

The microcomputer 135 is connected to a sub monitor driving circuit 121 through an I/O interface 136. The sub monitor driving circuit 121 is connected to the sub monitor 111. The sub monitor 111 is controlled by the sub monitor driving circuit 121 based on a control signal from the CPU 131.

The microcomputer 135 is connected to a touch panel driving circuit 122 through the I/O interface 136. The touch panel driving circuit 122 is connected to the touch panel 112. The touch panel 112 inputs an instruction through a touch operation by a player (touch position) to the CPU 131 through a coordinate signal from the touch panel driving circuit 122.

The microcomputer 135 is connected to a hopper driving circuit 123 through the I/O interface 136. The hopper driving circuit 123 is connected to the hopper 113. Payout by the hopper 113 is controlled by the hopper driving circuit 123 based on a control signal outputted from the CPU 131. After the payout control operation has been carried out, the hopper 113 pays out a predetermined number of coins to the coin payout portion 143 (refer to FIG. 2).

The microcomputer 135 is connected to a payout complete signal driving circuit 124 through the I/O interface 136. The payout complete signal driving circuit 124 is connected to the coin detecting sensor 114. If the coin detecting sensor 114 detects that a predetermined number of coins have been paid out from the coin payout portion 143 (refer to FIG. 2), it outputs an input signal to the CPU 131. The coin detecting sensor 114 is provided inside the coin payout portion 143 (refer to FIG. 2).

The microcomputer 135 is connected to a communication interface 125 through the I/O interface 136. The communication interface 125 is connected to the main control unit 12 of the host 11 and the sub control units 102 of the other stations 101. As a result, communication can be carried out in two directions between the CPU 131 and the host 11. The CPU 131 carries out command transmission and reception, request transmission and reception, data transmission and reception and the like with the host 11 through the communication interface 125. The same operations are also carried out between stations 101 themselves. Accordingly, in the gaming machine 1, the sub control unit 102 controls progress of the game in cooperation with the host 11.

The microcomputer 135 is connected to the operation button 115 through the I/O interface 136. When the operation button 115 is depressed, an input signal is outputted to the CPU 131 from the depressed operation button 115.

The microcomputer 135 is connected to a speech input circuit 126 through the I/O interface 136. The speech input circuit 126 is connected to the microphone 116. The speech captured by the microphone 116 is converted to speech data by the speech input circuit 126.

The microcomputer 135 is connected to a speech output circuit 127 through the I/O interface 136. The speech output circuit 127 is connected to the speaker 117. The output of the speaker 117 is controlled by the speech output circuit 127 based on a control signal from the CPU 131.

The microcomputer 135 is connected to a bill identifying device driving circuit 128 through the I/O interface 136. The bill identifying device driving circuit 128 is connected to the bill identifying device 118. The bill identifying device 118 identifies whether the bills and tickets with barcodes are adequate. More specifically, the bill identifying device 118 inputs the amount of the regular bills to the CPU 131 through an identification signal from the bill identifying device driving circuit 128. The bill identifying device 118 inputs the number of credits which are recorded in the regular tickets with barcodes from the bill identifying device driving circuit 128 to the CPU 131, through an identification signal. The bill identifying device 118 is provided inside the bill insertion portion 142 (refer to FIG. 2).

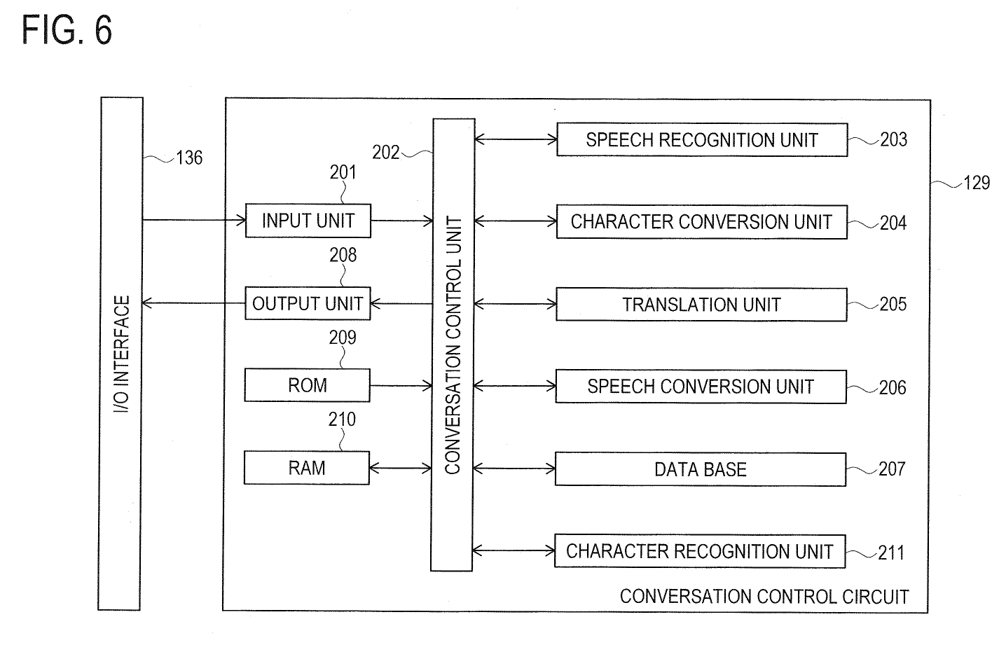

The microcomputer 135 is connected to a conversation control circuit 129 through the I/O interface 136. The conversation control circuit 129 serves to convert the speech data or character data that was inputted into speech data or character data in the output language. FIG. 6 is a block diagram showing the conversation control circuit 129.

The conversation control circuit 129 is constituted of an input unit 201, a conversation control unit 202, a speech recognition unit 203, a character conversion unit 204, a translation unit 205, a speech conversion unit 206, a data base 207, an output unit 208, a ROM 209, a RAM 210 and a character recognition unit 211 or the like. The input unit 201 serves to acquire speech data or character data through the I/O interface 136. The conversation control unit 202 serves to cause the conversation control circuit 129 to operate based on a control signal from the CPU 131. The speech recognition unit 203 serves to identify the language of the speech data. The character conversion unit 204 serves to convert the speech data into character data.

The translation unit 205 serves to translate character data in a language other than the output language into character data in the output language. The speech conversion unit 206 serves to convert the character data into speech data. The data base 207 serves to store various data (including game history) required by the speech recognition unit 203, the character conversion unit 204, the translation unit 205, the speech conversion unit 206 and the character recognition unit 211 and the like to operate. The output unit 208 serves to output speech data or character data to the I/O interface 136.

The ROM 209 serves to store various types of programs and data tables and the like to execute processing required for the control of the conversation control circuit 129. The RAM 210 serves to temporarily store various types of data and the like that was computed by the conversation control unit 202. The character recognition unit 211 serves to identify the language of the character data.

The conversation control circuit 129 analyzes the contents spoken by the player and can create a reply with respect to these contents. This conversation technique is in the public domain, and therefore, further description thereof is hereby omitted. When creating the reply, the conversation control circuit 129 references the game history inside the data base 207.

### [5. Example of Display on Sub Monitor]

FIG. 1, FIG. 7 and FIG. 8 are views showing examples of a display on the sub monitor 111. The sub monitor 111 displays bet buttons 75, a Repeat bet button 76, an UNDO bet button 77, a HELP button 84 and the like.

The bet buttons 75 include three types of buttons, as in “1 credit”, “10 credits” and “100” credits. The bet buttons 75 serve to select a bet amount for the current bet operation when touched by a player. The Repeat bet button 76 serves to set the bet amount for the current bet operation to the same bet amount as in the previous bet operation, when touched by the player. The UNDO bet button 77 serves to cancel a bet operation that was once carried out when touched by the player. The HELP button 84 serves to display an operation method of the gaming machine 1 onto the sub monitor 111 when touched by the player.

The sub monitor 111 has a bet amount display area 90, an acquired amount display area 91, a credit amount display area 92, a lower limit bet amount display area 93, an upper limit bet amount display area 94 and the like. The bet amount display area 90 displays the bet amount that the player is betting at the moment. The acquired amount display area 91 displays the amount awarded to the player in the game, as prize. The credit amount display area 92 displays the number of credits the player has at present. The lower limit bet amount display area 93 displays a lower limit of the bet amount that the player can bet. The upper limit bet amount display area 94 displays an upper limit of the bet amount that the player can bet.

The sub monitor 111 displays the station selecting button 89. The station selecting button 89 is touched by the player to change the settings of the output station. The output station includes a station 101 that outputs the speech of the player. The output station at the time of default is set to all stations 101.

The station selecting button 89 includes an all-station selecting button 89A, a station B selecting button 89B, a station C selecting button 89C, a station D selecting button 89D and a station E selecting button 89E, as shown in FIG. 1, FIG. 7 and FIG. 8. Accordingly, the sub monitor 111 displayed in FIG. 1, FIG. 7 and FIG. 8 is provided in station A. Although not shown, the sub monitor 111 of stations B, C, D and E includes a station A selecting button.

In FIG. 1 and FIG. 7, both ends of the all-station selecting button 89A are displayed in a specific color. In FIG. 8, both ends of the station E selecting button 89E are shown in a specific color. Thus, the output station which is currently set is displayed by displaying both ends of the station selecting button 89 in a specific color.

Selection of the output station using the station B selecting button 89B, the station C selecting button 89C, the station D selecting button 89D and the station E selecting button 89E is possible only while these selecting buttons 89B, 89C, 89D and 89E are continuously touched by the player. When the player stops touching the buttons, all stations 101 are restored to the output station. For instance, station B is reset to the output station while the station B selecting button 89B is continuously touched by the player. When the player stops touching the button, all stations 101 are restored to the output station. This is also true for the station C selecting button 89C, the station D selecting button 89D, the station E selecting button 89E and the station A selecting button (not shown) which is displayed onto the sub monitor 111 of the stations B, C, D and E.

The sub monitor 111 includes the player's card display area 71, the chip display area 73, the message display area 85, the language selecting button 88, the game progress display area 95 and the like, as was described earlier.

FIG. 7 is an example of a demonstration display. The game progress display area 95 displays “GAME OVER!!”. In the demonstration, when the player makes an inquiry in English in front of the microphone 116, a reply is outputted in English to the message display area 85 and the speaker 117. In FIG. 7, the player makes an inquiry in English reading “Expectation?” in front of the microphone 116. As a reply, a sentence reading “This seat has a positive expectation!! Let's play some draw?” is outputted to the message display area 85, and at the same time, an audio message “This seat has a positive expectation!! Let's play some draw?” is outputted from the speaker 117. This message is similarly outputted in French, German and Japanese.

The FIG. 1 is an example of a display during a betting round in a poker game. When the player of another station 101 makes an utterance, the uttered contents are displayed on the message display area 85 in the output language, and at the same time, are outputted from the speaker 117 in the output language.

Further, the message display area 85 also displays characters to show the station 101 at which the player that made the utterance is seated. In FIG. 1, these characters correspond to “[st.E]”. “[st.E]” shows that the station 101 at which the player that made the utterance is seated is station E.

In FIG. 1, since the output language is set to English, the contents uttered by the player of station E (“Call.” in English) are displayed in English on the message display area 85. Further, the contents uttered by the player at station E (“Call.”) are outputted in English from the speaker 117. This is the same even for the case that the player of another station 101 makes an utterance in any one of the French, German and Japanese languages. The contents thus uttered are displayed in English on the message display area 85 and at the same time, are outputted in English from the speaker 117.

On the other hand, if the player utters “Raise.” in English in front of the microphone 116, as shown in FIG. 1, contents uttered by the player (“Raise.” in English) are displayed on the message display area 85 in the output language of each station 101. At the same time, the uttered contents are outputted from the speaker 117 in the output language of each station 101.

FIG. 8, as well, is an example of a display during a betting round of a poker game. Since the output language is set to English, the contents uttered by the player of station E (“You can't break up with me. I've got hand” in English) are displayed in English on the message display area 85. At the same time, the contents uttered by the player of station E (“You can't break up with me. I've got hand” in English) are outputted in English from the speaker 117.

In FIG. 8, the station E selecting button 89E is continuously touched by the player. Accordingly, the output station setting is changed to the station E. Thus, if the player utters in English “Your action, sir” in front of the microphone 116, as shown in FIG. 8, the contents uttered by the player (“Your action, sir.”) are displayed on the message display area 85 in the output language of the station E. At the same time, these contents are outputted from the speaker 117 in the output language of the station E.

### [6. Example of the Operation of the Gaming Machine]

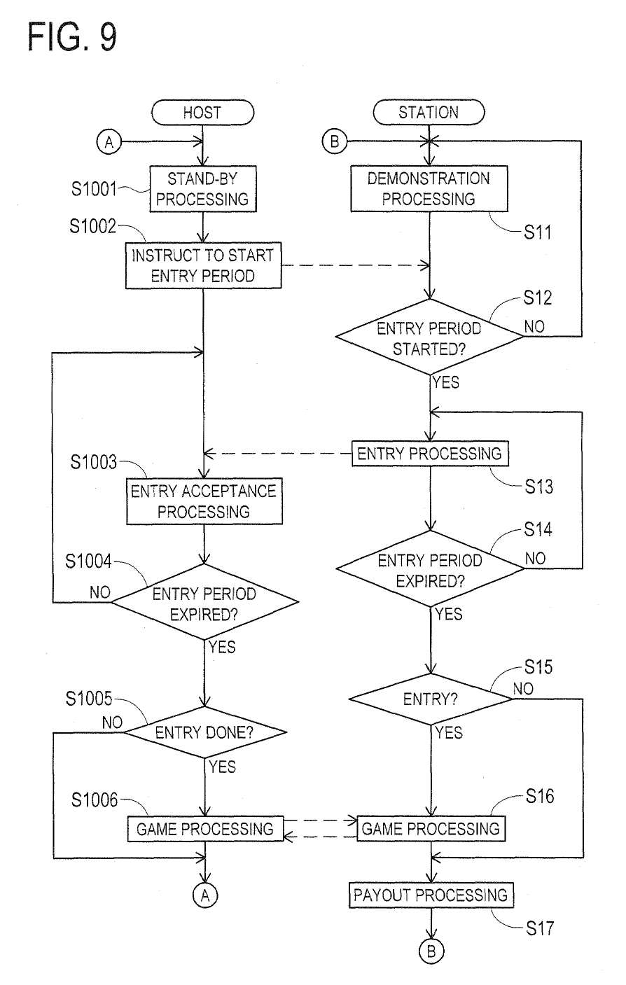

FIG. 9 is a flow chart diagram showing one example of the game operation in the gaming machine 1 according to the present embodiment. Each station 101 performs a similar game operation in cooperation with the host 11, respectively. To simplify the description, FIG. 9 shows only one station 101.

The host 11 carries out the respective operations from step (hereinafter referred to as S) 1001 to S1006. In S1001, the main control unit 12 executes a stand-by processing. In the stand-by processing, the main control unit 12 is in stand-by until a stand-by period lapses from the end of a previous game or the end of a previous entry period. After the stand-by period has lapsed, the flow proceeds to S1002.

In S1002, the main control unit 12 transmits an instruction signal instructing start of the entry period to each station 101. In S1003, the main control unit 12 executes an entry acceptance processing. In this entry acceptance processing, the main control unit 12 stores data for identifying the station 101 that transmitted a notification signal indicating entry in the game, in the game entry table. The game entry table is provided inside the RAM 42.

In S1004, the main control unit 12 determines whether the entry period has expired or not. Here, this determination is made that the entry period has expired, if a predetermined period has lapsed from execution of the S1002. If the entry period has not expired (S1004: NO), the flow returns to S1003, and the entry acceptance processing continues. On the other hand, if the entry period has expired (S1004: YES), the flow proceeds to S1005.

In S1005, the main control unit 12 determines whether an entry has been done or not. This determination is based on the game entry table used in S1003. Here, if an entry has not been done (S1005: NO), the flow returns to S1001. On the other hand, if an entry has been done (S1005: YES), the flow proceeds to S1006. In S1006, the main control unit 12 executes a game processing. In this game processing, the main control unit 12 controls the progress of the poker game, while performing data communication with each station 101. When the poker game is over, the flow returns to S1001.

Each station 101 carries out the operations from S11 to S17. In S11, the sub control unit 102 executes a demonstration processing. In this demonstration processing, the sub control unit 102 displays a demonstration image on the sub monitor 111 by transmitting a control signal to the sub monitor driving circuit 121. At the same time, the sub control unit 102 outputs a demonstration sound from the speaker 117 by transmitting a control signal to the speech output circuit 127.

At this time, when the player makes an utterance in front of the microphone 116, the sub control unit 102 inputs speech data from the speech input circuit 126 to the conversation control circuit 129. The conversation control circuit 129 analyzes the speech data and retrieves a reply with respect to the contents uttered by the player from the data base 207. The retrieved reply is outputted from the conversation control circuit 129 as character data and speech data. The character data outputted from the conversation control circuit 129 is displayed on the message display area 85 of the sub monitor 111. The speech data outputted from the conversation control circuit 129 is outputted from the speaker 117.

For instance, as shown in FIG. 7, when the player makes an inquiry in English reading “Expectation?” in front of the microphone 116, the conversation control circuit 129 analyzes the speech data “Expectation?” and retrieves a reply with respect to the contents uttered by the player from the data base 207. At this time, the conversation control circuit 129 retrieves, from the data base 207, the English sentences “This seat has a positive expectation!! Let's play some draw?”, as a reply to the inquiry “Expectation?”, while referencing the game history in the data base 207. Thus, the characters “This seat has a positive expectation!! Let's play some draw?” are outputted to the message display area 85. At the same time, the speech “This seat has a positive expectation!! Let's play some draw?” is outputted from the speaker 117.

In S12, the sub control unit 102 determines whether the entry period has started or not. This determination is carried out based on an instruction signal received from the host 11. Here, if the entry period has not started (S12: NO), the flow returns to S11 and the demonstration processing is next executed. On the other hand, if the entry period has started (S12: YES), the flow proceeds to S13.

In S13, the sub control unit 102 executes an entry processing. In the entry processing, the sub control unit 102 transmits a notification signal indicating entry to the game to the host 11, only if the player has made an entry operation. The entry operation is carried out by a touch operation using the touch panel 112. Description of this entry operation is omitted.

In S14, the sub control unit 102 determines whether the entry period has expired or not. Here, this determination is made that the entry period has expired if a predetermined period has lapsed from the time an instruction signal instructing start of the entry period is received from the host 11. Here, if the entry period has not expired (S14: NO), the flow returns to S13 and the entry processing is next executed. On the other hand, if the entry period has expired (S14: YES), the flow proceeds to S15.

In S15, the control unit 102 determines whether an entry has been made or not. Here, this determination is made that entry has been made if the notification signal showing entry to the game in S13 is transmitted to the host 11. Here, if entry has not been made (S15: NO), the flow proceeds to S17 described below. On the other hand, if entry has been made (S15: YES), the flow proceeds to S16. In S16, the sub control unit 102 executes a game processing. In this game processing, the sub control unit 102 controls the progress of the poker game, while carrying out data communication with the host 11. The sub control unit 102 stores the game results and the like at this time in the data base 207 of the conversation control circuit 129.

When the poker game is over, the flow proceeds to S17. In S17, the sub control unit 102 executes a payout processing. Thereafter, the flow returns to S11.

### [7. Example of Interrupt Operation in the Station]

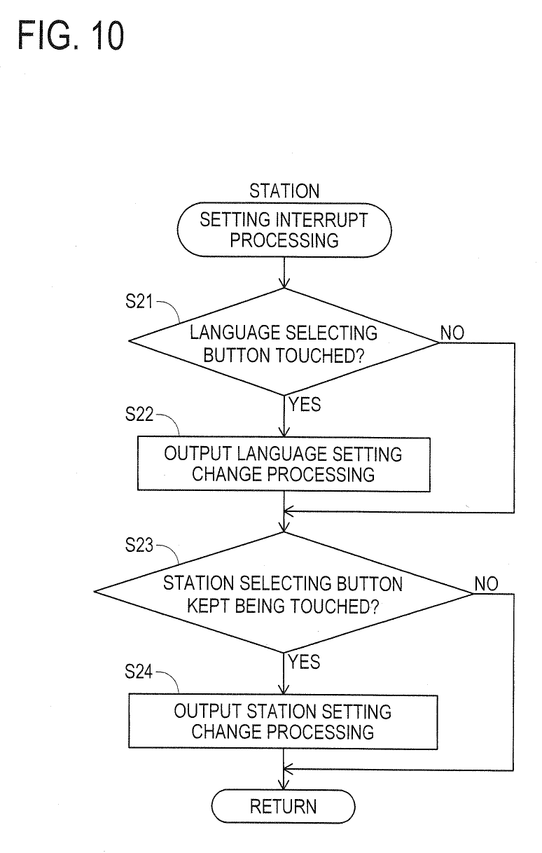

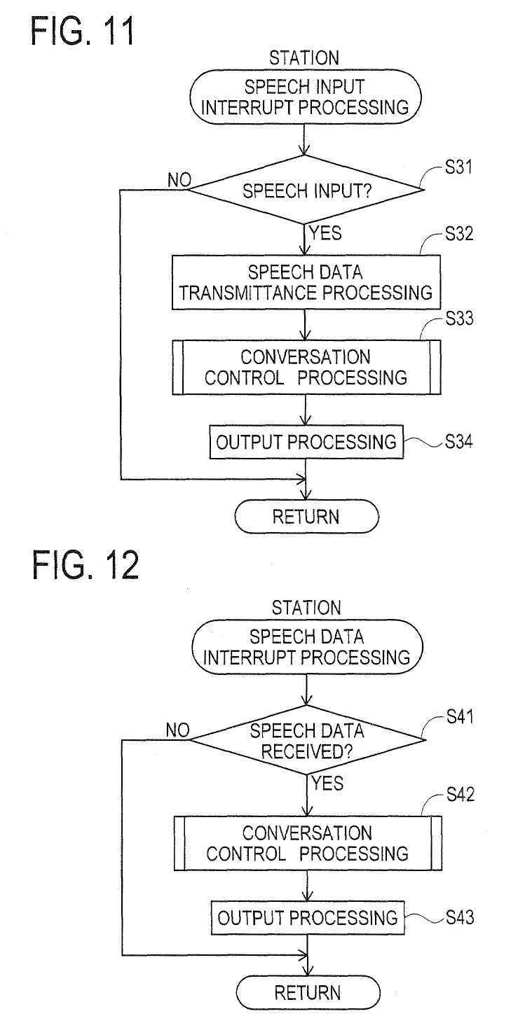

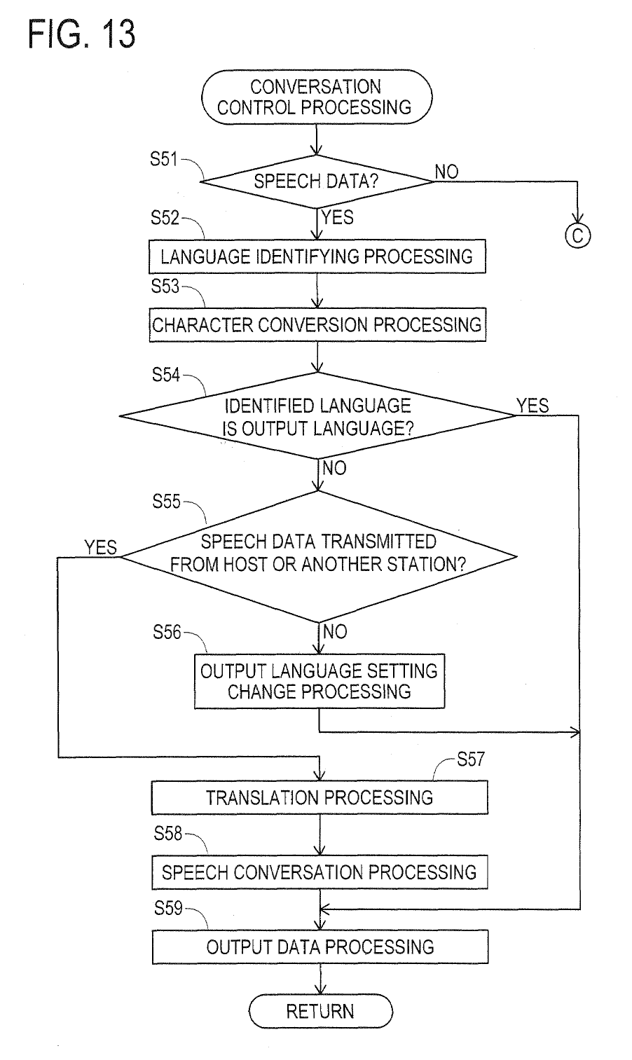

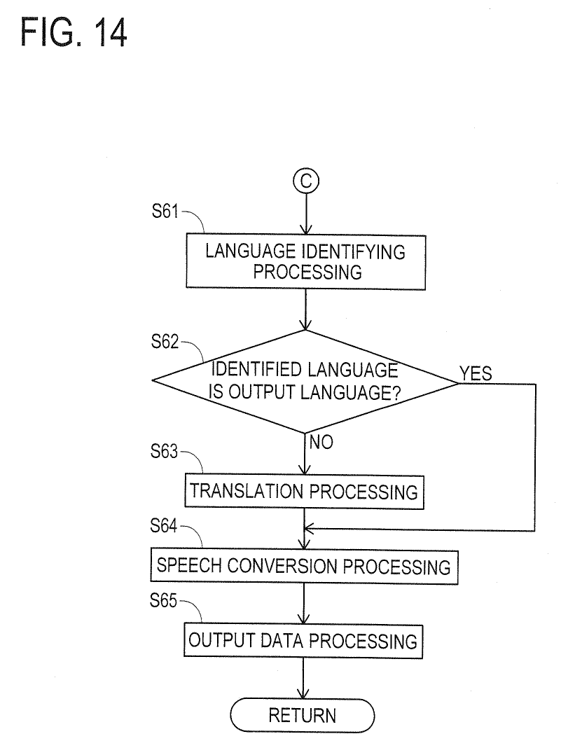

FIG. 10 through FIG. 12 are flow chart diagrams showing an interrupt processing in each station 101 constituting the gaming machine 1 according to the present embodiment. FIG. 10 is a flow chart diagram showing a setting interrupt processing. FIG. 11 is a flow chart diagram showing a speech input interrupt processing. FIG. 12 is a flow chart diagram showing a speech data interrupt processing. The respective interrupt processing shown in FIG. 10 through FIG. 12 is executed by the sub control unit 102 once every predetermined period. FIG. 13 and FIG. 14 are flow chart diagrams showing conversation control processing in FIG. 11 and FIG. 12.

The setting interrupt processing shown in FIG. 10 will now be described. In S21, the sub control unit 102 determines whether the language selecting button 88 has been touched or not. This determination is carried out based on a coordinate signal from the touch panel driving circuit 122. Here, if the language selecting button 88 has not been touched (S21: NO), the flow proceeds to S23 described below. On the other hand, if the language selecting button 88 has been touched (S21: YES), the flow proceeds to S22.

In S22, the sub control unit 102 executes an output language setting change processing. In this output language setting change processing, the sub control unit 102 identifies the language selecting button 88 which is at a position shown by the coordinate signal, based on the coordinate signal from the touch panel driving circuit 122. The sub control unit 102 then sets the language shown by the identified language selecting button 88 as the output language. Further, the sub control unit 102 displays only both ends of the identified language selecting button 88 in a specific color by transmitting a control signal to the sub monitor driving circuit 121. For instance, if the player touches the Japanese selecting button 88D, Japanese is set as the output language, and only both ends of the Japanese selecting button 88D are displayed in a specific color. The sub control unit 102 stores the changed output language in the data base 207 of the conversation control circuit 129, each time the output language is changed. Then, the flow proceeds to S23.

In S23, the sub control unit 102 determines whether the station selecting button 89 is kept being touched or not. This determination is carried out based on a coordinate signal from the touch panel driving circuit 122. Here, if the station selecting button 89 is not kept being touched (S23: NO), the setting interrupt processing shown in FIG. 10 is ended. On the other hand, if the station selecting button 89 is kept being touched (S23: YES), the flow proceeds to S24.

In S24, the sub control unit 102 executes a setting change processing of the output station. In the setting change processing of the output station, the sub control unit 102 identifies the station selecting button 89 which is in the position shown by the coordinate signal based on the coordinate signal from the touch panel driving circuit 122. Simple continuous touching of the station selecting button 89 helps set the station shown by the identified station selecting button 89 as the output station. Further, the sub control unit 102 displays only both ends of the identified language selecting button 88 in a specific color by transmitting a control signal to the sub monitor driving circuit 121, only when the station selecting button 89 is continuously touched.

For instance, when the player continuously touches the station E selecting button 89E, both ends of the station E selecting button 89E are displayed in a specific color, and the station E is set as the output station, as shown in FIG. 8. If the player stops touching the station E selecting button 89E, only both ends of the all station selecting button 89A is displayed in a specific color and all the stations 101 are restored to the output station, as shown in FIG. 1 and FIG. 7. Then, the setting interrupt processing shown in FIG. 10 is ended.

The speech input interrupt processing shown in FIG. 11 will next be described. In S31, the sub control unit 102 determines whether input of a speech has been made to the microphone 116 or not. This determination is based on the speech data from the speech input circuit 126. Here, if no speech input is made to the microphone 116 (S31: NO), the speech input interrupt processing shown in FIG. 11 is ended. On the other hand, if a speech input is made to the microphone 116 (S31: YES), the flow proceeds to S32.

In S32, the sub control unit 102 executes a speech data transmittance processing. In this speech data transmittance process, the sub control unit 102 transmits speech data from the speech input circuit 126 to the station 101 set as the output station. At this time, data for identifying the station 101 from where transmittance was made is attached to the speech data. Thereafter, the flow proceeds to S33.

In S33, the sub control unit 102 executes a conversation control processing. In this conversation control processing, the sub control unit 102 inputs speech data from the speech input circuit 126 to the conversation control circuit 129. In the conversation control circuit 129, the speech data thus inputted is converted to speech data and character data represented in the output language and the result is then outputted. A detailed description thereof will be given using FIG. 13 and FIG. 14.

In S34, the sub control unit 102 executes an output processing. In this output processing, the sub control unit 102 transmits a control signal to the speech output circuit 127. As a result, the speaker 117 outputs speech data transmitted from the conversation control circuit 129. The sub control unit 102 also transmits a control signal to the sub monitor driving circuit 121. As a result, the message display area 85 in the sub monitor 111 displays character data from the conversation control circuit 129. Thereafter, the speech input interrupt processing shown in FIG. 11 is ended.

The speech data interrupt processing as shown in FIG. 12 will next be described. In S41, the sub control unit 102 determines whether speech data has been received or not. This determination is carried out based on the signal outputted from the communication interface 125 when speech data was received. The speech data is transmitted from the other stations 101 or the host 11. Here, if speech data has been not received (S41: NO), the speech data interrupt processing shown in FIG. 12 is ended. On the other hand, if speech data has been received (S41: YES), the flow proceeds to S42.

In S42, the sub control unit 102 executes a conversation control processing. In this conversation control processing, the sub control unit 102 inputs the speech data from another station 101 or the host 11 to the conversation control circuit 129. In the conversation control circuit 129, the speech data thus inputted is converted to speech data and character data represented in the output language and the result is then outputted. A detailed description thereof will be given using FIG. 13 and FIG. 14.

In S43, the sub control unit 102 executes an output processing. In this output processing, the sub control unit 102 transmits a control signal to the speech output circuit 127. As a result, the speaker 117 outputs speech data transmitted from the conversation control circuit 129. The sub control unit 102 transmits a control signal to the sub monitor driving circuit 121. As a result, the message display area 85 of the sub monitor 111 displays the character data transmitted from the conversation control circuit 129. At this time, the sub control unit 102 identifies the source of the transmission from the data attached to the speech data outputted from another station 101 or the host 11. Then, the sub control unit 102 displays the characters showing the identified source of the transmission (for instance, “[st.E]” as shown in FIG. 1) on the message display area 85 in the sub monitor 111. Thereafter, the speech data interrupt processing as shown in FIG. 12 is ended.

A description will now be given on the conversion control processing shown in FIG. 13 and FIG. 14. This conversation control processing includes the conversation control processing in S33 in FIG. 11 and the conversation control processing in S42 in FIG. 12. This conversation control processing is executed by the conversion control unit 202 of the conversation control circuit 129.

In S51 in FIG. 13, the conversation control unit 202 determines whether the data inputted to the conversation control circuit 129 is speech data or not. This determination is based on a signal outputted from the input unit 201 at the time of speech data input. Here, if the data inputted to the conversation control circuit 129 is speech data (S51: YES), the flow proceeds to S52.

In S52, the conversation control unit 202 executes a language identification processing. In the language identification processing, the conversation control unit 202 transmits a control signal to the speech recognition unit 203. As a result, the language of the speech data is identified by the speech recognition unit 203. Identification is made by referencing the data stored in the data base 207. The speech data is stored in the RAM 210 as output speech data.

In S53, the conversation control unit 202 executes a character conversion processing. In this character conversion processing, the conversation control unit 202 transmits a control signal to the character conversion unit 204. As a result, the speech data is converted into character data in the character conversion unit 204. In this conversion processing, the speech data is converted to character data in the language identified in the speech recognition unit 203. The character data thus converted is stored in the RAM 210 as output character data. The conversion at this time is made by referencing the data stored in the data base 207.

In S54, the conversation control unit 202 determines whether the language identified by the speech recognition unit 203 coincides with the output language or not. Here, if the language identified by the speech recognition unit 203 coincides with the output language (S54: YES), the flow proceeds to S57 described below. On the other hand, if the language identified by the speech recognition unit 203 differs from the output language (S54: NO), the flow proceeds to S55.

In S55, the conversation control unit 202 determines whether the speech data inputted to the conversation control circuit 129 has been transmitted from the host 11 or another station 101 or not. This determination is based on the data attached to the speech data. Here, if the speech data inputted to the conversation control circuit 129 has been not transmitted from the host 11 or another station 101 (S55: NO), the flow proceeds to S56.

In S56, the conversation control unit 202 executes an output language setting change processing. In the output language setting change processing, the conversation control unit 202 performs setting change of the language identified by the speech recognition unit 203 to the output language. The sub control unit 102 transmits a signal notifying the changed output language to the host 11 each time the output language is changed. Thereafter, the flow proceeds to S59 described below.

On the other hand, if the speech data inputted to the conversation control circuit 129 has been transmitted from the host 11 or another station 101 (S55: YES), the flow proceeds to S57. In S57, the conversation control unit 202 executes a translation processing. In this translation processing, the conversation control unit 202 transmits a control signal to the translation unit 205. As a result, the character data converted in the character conversion unit 204 is converted to character data in the output language by the translation unit 205. Here, the character data thus converted is overwritten in the RAM 210 as the output character data. The conversion at this time is made by referencing the data stored in the data base 207.

In S58, the conversation control unit 202 executes a speech conversion processing. In the speech conversion processing, the conversation control unit 202 transmits a control signal to the speech conversion unit 206. As a result, character data converted in the translation unit 205 is converted to speech data in the output language by the speech conversion unit 206. The speech data converted here is overwritten in the RAM 210 as the output speech data. The conversion at this time is made by referencing the data stored in the data base 207.

In S59, the conversation control unit 202 executes an output data processing. In this output data processing, the conversation control unit 202 transmits a control signal to the output unit 208. In turn, the output unit 208 outputs the output speech data and the output character data inside the RAM 210 from the conversation control circuit 129. Thereafter, the conversation control processing is ended.

On the other hand, if the data inputted to the conversation control circuit 129 is character data (S51: NO), the flow proceeds to S61 in FIG. 14. In S61, the conversation control unit 202 executes a language identifying process. In the language identifying process, the conversation control unit 202 transmits a control signal to the character recognition unit 211. In turn, the character recognition unit 211 identifies the language of the character data. The identification is here carried out by referencing the data stored in the data base 207. The character data is stored in the RAM 210 as output character data.

In S62, the conversation control unit 202 determines whether the language identified by the character recognition unit 211 coincides with the output language ore not. Here, if the language identified by the character recognition unit 211 coincides with the output language (S62: YES), the flow proceeds to S64 described below. On the other hand, if the language identified by the character recognition unit 211 differs from the output language (S62: NO), the flow proceeds to S63.

In S63, the conversation control unit 202 executes a translation processing. In this translation processing, the conversation control unit 202 transmits a control signal to the translation unit 205. The translation unit 205 then converts the character data to character data in the output language. The character data converted here is overwritten in the RAM 21 as the output character data. The conversion at this time is made by referencing the data stored in the data base 207.

In S64, the conversation control unit 202 executes a speech conversion processing. In the speech conversion processing, the conversation control unit 202 transmits a control signal to the speech conversion unit 206. The speech conversion unit 106 then converts the character data converted in the translation unit 205 into speech data in the output language. The speech data converted here is stored in the RAM 210 as output speech data. The conversion at this time is made by referencing the data stored in the data base 207.

In S65, the conversation control unit 202 executes an output data processing. In this output data processing, the conversation control unit 202 transmits a control signal to the output unit 208. In turn, the output unit 208 outputs the output speech data and the output character data inside the RAM 210 from the conversation control circuit 129. Thereafter, the conversation control processing is ended.

Accordingly, upon receiving the speech data and the character data, the conversation control circuit 129 converts this data to speech data and character data in the output language and outputs the result.

### [8. Other]

The present disclosure is not limited to the above-described embodiment, and various changes can be made thereto without departing from the spirit of the disclosure.

For instance, the game executed in the gaming machine 1 according to the present embodiment is not limited to draw poker. The game may also include various types of card games such as poker, Blackjack, Baccarat and other multi-player games.

What is claimed is:

1. A gaming machine has a plurality of stations, each station comprising:
an output device to which speech data or character data corresponding to conversation information with respect to a game history is outputted in an output language set in the station;
an input device that converts a speech of a player into speech data;
a speech recognition device that identifies a language of the speech data;
a character conversion device that converts the speech data whose language was identified in the speech recognition device into character data in the identified language;
a translation device that converts character data converted in the character conversion device into character data in the output language;
a speech conversion device that converts the character data converted in the character conversion device or translation device into speech data in the output language;
a communication device that carries out data communication with respect to other stations;
a station selecting device that selects one station from the other stations; and
a processor that is programmed to cause the communication device to transmit speech data that was converted in the input device to the station selected by the station selecting device, and at the same time, is programmed to execute processing (1) through (3) as follows:
(1) identifying the language of the speech data that is received from the other stations through the communication device by the speech recognition device:
(2) if the language identified at the processing (1) coincides with the output language, converting the speech data received at the processing (1) into character data in the language identified at the processing (1) by the character conversion device, and outputting the character data or the speech data thus converted to the output device in the output language; and
(3) if the language identified at the processing (1) differs from the output language, subjecting the speech data received at the processing (1) to a first conversion into character data in the language identified at the processing (1) by the character conversion device, subjecting the character data that was subjected to the first conversion to a second conversion into character data in the output language by the translation device, and subjecting the character data that was subjected to the second conversion to a third conversion into speech data in the output language by the speech conversion device, and outputting the character data that was subjected to the second conversion or the speech data that was subjected to the third conversion to the output device in the output language.

2. The gaming machine according to claim 1, wherein, if a same game is executed simultaneously in the station and another station, the processor is programmed to execute the processing (1) through (3) in a timing required by a player of the station to make an utterance regarding the game with respect to a player of the station selected by the station selecting device.

3. The gaming machine according to claim 1, wherein the processor is programmed to execute processing (4) through (6) as follows:
(4) identifying the language of the speech data converted in the input device by the speech recognition device;
(5) maintaining the setting of the output language, if the language identified at the processing (4) coincides with the output language; and
(6) changing the setting of the output language to the language identified at the processing (4), if the language identified at the processing (4) differs from the output language.

4. The gaming machine according to claim 1,
further comprising a language selecting device that selects one language from a plurality of languages, and
wherein the processor is programmed to execute processing (7) as follows:
(7) changing the setting of the output language to the language selected in the language selecting device.

5. The gaming machine according to claim 1, wherein, if a same game is executed simultaneously in the station and another station, the processor is programmed to execute the processing (1) through (3) and processing (4) through (6) as follows in a timing required by a player of the station to make an utterance relating to the game with respect to a player of the station selected by the station selecting device:
(4) identifying the language of the speech data converted in the input device by the speech recognition device;
(5) maintaining the setting of the output language, if the language identified at the processing (4) coincides with the output language; and
(6) changing the setting of the output language to the language identified at the processing (4), if the language identified at the processing (4) differs from the output language.

6. The gaming machine according to claim 1,
further comprising a language selecting device that selects one language from a plurality of languages; and
wherein the processor is programmed to execute processing (4) through (7) as follows:
(4) identifying the language of the speech data converted in the input device by means of the speech recognition device;
(5) maintaining the setting of the output language, if the language identified at the processing (4) coincides with the output language;
(6) changing the setting of the output language to the language identified at the processing (4), if the language identified at the processing (4) differs from the output language; and
(7) changing the setting of the output language to the language selected in the language selecting device.

7. The gaming machine according to claim,
further comprising a language selecting device that selects one language from a plurality of languages; and
wherein, if a same game is executed simultaneously between the station and another station, the processor is programmed to execute the processing (1) through (3) and processing (7) as follows in a timing required by a player of the station to make an utterance regarding the game with respect to a player of the station selected by the station selecting device:
(7) changing the setting of the output language to the language selected in the language selecting device.

8. A gaming machine having a plurality of stations, each station comprising:
an output device to which speech data or character data corresponding to conversation information with respect to a game history is outputted in an output language set in the station;
an input device that converts a speech of a player into speech data;
a speech recognition device that identifies a language of the speech data;
a character conversion device that converts the speech data whose language was identified in the speech recognition device into character data in the identified language;
a translation device that converts character data that was converted in the character conversion device into character data in the output language;
a speech conversion device that converts the character data converted in the character conversion device or translation device into speech data in the output language;
a communication device that carries out data communication with respect to other stations;
a station selecting device that selects one station from the other stations;
a language selecting device that selects one language from a plurality of languages; and
a processor that is programmed to cause the communication device to transmit speech data that was converted in the input device to the station selected by the station selecting device, and at the same time, if a same game is executed simultaneously in the station and another station, the processor is programmed to execute processing (1) through (7) as follows in a timing required by a player of the station to make an utterance regarding the game with respect to a player of the station selected by the station selecting device:
(1) identifying the language of the speech data that is received from the other stations through the communication device by the speech recognition device;
(2) if the language identified at the processing (1) coincides with the output language, converting the speech data received at the processing (1) into character data in the language identified at the processing (1) by the character conversion device, and outputting the character data or the speech data thus converted to the output device in the output language;
(3) if the language identified at the processing (1) differs from the output language, subjecting the speech data received at the processing (1) to a first conversion into character data in the language identified at the processing (1) by the character conversion device, subjecting the character data that was subjected to the first conversion to a second conversion into character data in the output language by the translation device, and subjecting the character data that was subjected to the second conversion to a third conversion into speech data in the output language by the speech conversion device, and outputting the character data that was subjected to the second conversion or the speech data that was subjected to the third conversion in the output device in the output language;
(4) identifying the language of the speech data converted in the input device by the speech recognition device;
(5) maintaining the setting of the output language, if the language identified at the processing (4) coincides with the output language;
(6) changing the setting of the output language to the language identified at the processing (4), if the language identified at the processing (4) differs from the output language; and
(7) changing the setting of the output language to the language selected in the language selecting device.
